(19) United States
(12) Patent Application Publication
(10) Pub. No.: US 2016/0198538 A1
(43) Pub. Date: Jul. 7, 2016

(54) LED DRIVE CIRCUIT

(71) Applicants: Daisung Moon, Seoul (KR); Sangpil Moon, Seoul (KR)

(72) Inventors: Daisung Moon, Seoul (KR); Sangpil Moon, Seoul (KR)

(21) Appl. No.: 14/723,483

(22) Filed: May 28, 2015

Related U.S. Application Data
(63) Continuation-in-part of application No. PCT/CN2015/070096, filed on Jan. 5, 2015.

(51) Int. Cl. H05B 33/08

(52) U.S. Cl. CPC H05B 33/0815; H05B 33/0887

(57) ABSTRACT

Disclosure relates to an LED drive circuit, comprising a transformer, a first NPN transistor (Q1) and a negative feedback unit connected between an emitter and a collector of the first NPN transistor (Q1), a tenth capacitor (C10), a fifth resistor (R5) and a secondary winding (T1B) of the transformer are connected in series between the base of the first NPN transistor(Q1) and the negative output terminal of the AC-DC conversion unit, a primary winding (T1A) of the transformer is electrically connected between the collector of the first NPN transistor (Q1) and a positive output terminal of the AC-DC conversion unit; the base of the first NPN transistor (Q1), a ninth resistor (R9), a second backward diode (D2) and the positive output terminal of the AC-DC conversion unit are electrically connected in series.

### CROSS-REFERENCE TO RELATED APPLICATIONS

The present application is a Continuation-in-part application of PCT application No. PCT/CN2015/070096 filed on Jan. 5, 2015, the contents of which are hereby incorporated by reference.

### FIELD OF THE INVENTION

The present invention relates to LED (light emitting diode) lighting, especially to an LED drive circuit for dimming an LED, the LED drive circuit can be connected to a leading edge dimmer or a trailing edge dimmer to realize the dimming of LED without utilizing an integrated circuit (IC).

### BACKGROUND OF THE INVENTION

As shown in FIG. 1, a traditional LED drive circuit utilizes an integrated circuit U1 to drive and dim an LED. The integrated circuit, however, is much more expensive than metal-oxide-semiconductor field-effect transistors (MOSFET) or bipolar junction transistors (BJT), with the BJT having the lowest price. Therefore, the integrated circuit results in a high manufacturing cost of the traditional LED drive circuit which hinders the development of environment-friendly LED lighting applications. Until now, no BJT-based LED drive circuit is available to drive or dim an LED.

### SUMMARY OF THE INVENTION

The present invention provides an LED drive circuit which utilizes BM instead of an integrated circuit to drive and dim an LED.

The LED drive circuit of the present invention comprises an AC-DC conversion unit at input terminals of the LED drive circuit, characterized in that the LED drive circuit further comprises a transformer, a first NPN transistor (Q1) and a negative feedback unit connected between an emitter and a collector of the first NPN transistor (Q1), the base of the first NPN transistor (Q1), a tenth resistor (R10) and a negative output terminal of the AC-DC conversion unit are electrically connected in series , a tenth capacitor (C10), a fifth resistor (R5) and a secondary winding (T1B) of the transformer are connected in series between the base of the first NPN transistor (Q1) and the negative output terminal of the AC-DC conversion unit, a primary winding (T1A) of the transformer is electrically connected between the collector of the first NPN transistor (Q1) and a positive output terminal of the AC-DC conversion unit; the base of the first NPN transistor (Q1), a ninth resistor (R9), a second backward diode (D2) and the positive output terminal of the AC-DC conversion unit are electrically connected in series, a negative output terminal of the LED drive circuit is connected between the ninth resistor (R9) and the second backward diode (D2); the emitter of the first NPN transistor (Q1), an eleventh resistor (R11) and the negative output terminal of the AC-DC conversion unit are electrically connected in series; the collector of the first NPN transistor (Q1), a first forward diode (D1) and a positive output terminal of the LED drive circuit are electrically connected in series; and a twelfth resistor (R12) and a filter capacitor (CE1) are connected in parallel between the positive output terminal of the LED drive circuit and the positive output terminal of the AC-DC conversion unit.

Preferably, the negative feedback unit comprises a second NPN transistor (Q2); a base of the second NPN transistor (Q2), a eighth resistor (R8), a forth resistor (R4) and the emitter of the NPN transistor (Q1) are electrically connected in series, combined bias resistors comprising a seventh resistor (R7) and a thermistor (RT1) are electrically connected between the base of the second NPN transistor (Q2) and the negative output terminal of the AC-DC conversion unit; a collector of the second NPN transistor (Q2) is electrically connected to the base of the NPN transistor (Q1), the collector of the second NPN transistor (Q2) is also electrically connected in series to the tenth capacitor (C10), the fifth resistor (R5) and one terminal of a third resistor (R3), the other terminal of the third resistor (R3) is electrically connected between the eighth resistor (R8) and the forth resistor (R4); and an emitter of the second NPN transistor (Q2) is electrically connected to the negative output terminal of the AC-DC conversion unit.

Preferably, the negative feedback unit comprises a third NPN transistor (Q3) and a forth NPN transistor (Q4); a base of the third NPN transistor (Q3) is electrically connected in series to a eighth resistor (R8), a forth resistor (R4) and the emitter of the first NPN transistor (Q1), combined bias resistors comprising a seventh resistor (R7) and a thermistor (RT1) are electrically connected between the base of the third NPN transistor (Q3) and the negative output terminal of the AC-DC conversion unit; a collector of the third NPN transistor (Q3) and a collector of the forth NPN transistor (Q4) both are connected to the base of the NPN transistor (Q1), the collector of the third NPN transistor (Q3) and the collector of the forth NPN transistor (Q4) are also connected in series to the tenth capacitor (C10), the fifth resistor (R5) and one terminal of a third resistor (R3), the other terminal of the third resistor (R3) is electrically connected to a mid-node of the eighth resistor (R8) and the forth resistor (R4); and an emitter of the third NPN transistor (Q3) is electrically connected to a base of the forth NPN transistor(Q4), and an emitter of the forth NPN transistor (Q4) is electrically connected to the negative output terminal of the AC-DC conversion unit.

Preferably, the LED drive circuit further comprises a second resistor (R2) and a second capacitor (C2) connected in series between the positive output terminal and the negative output terminal of the AC-DC conversion unit.

Preferably, a leading edge dimmer or a trailing edge dimmer is connected between the LED drive circuit and an external AC supply.

Preferably, the LED drive circuit further comprises an electromagnetic interference prevention unit connected between the positive output terminal and the negative output terminal of the AC-DC conversion unit.

Preferably, a part of the electromagnetic interference prevention unit connected to an input terminal of the AC-DC conversion unit comprises a sixth resistor (R6) and an arc suppression coil (LF1) that are connected in parallel between a first input terminal (N) of the LED drive circuit and the AC-DC conversion unit.

Preferably, a part of the electromagnetic interference prevention unit connected to output terminals of the AC-DC conversion unit comprises a first inductor (L1), a first resistor (R1), a first capacitor (C1) and a third capacitor (C3); the first inductor (L1) and the first resistor (R1) that are connected in parallel are connected in series to one terminal of the first capacitor (C1) to form a branch, the branch and the third capacitor (C3) are connected in parallel between the positive output terminal of the AC-DC conversion unit and the negative output terminal of the AC-DC conversion unit; the other terminal of the first capacitor (C1) is an input terminal of a next stage circuit.

Preferably, the LED drive circuit further comprises a protective tube (F1) connected between a second input terminal (L) of the LED drive circuit and the AC-DC conversion unit.

Preferably, the LED drive circuit further comprises a metal-oxide varistor (MOV1) connected between a first input terminal (N) and a second input terminal (L) of the LED drive circuit.

As compared with existing LED drive circuits, the LED drive circuit of the present invention that utilizes BJTs instead of an integrated circuit to drive and dim an LED has the following advantages:

1. The manufacturing cost of the LED drive circuit of the present invention substantially goes down.

2. The LED drive circuit of the present invention prevents electromagnetic resonances and avoids flashing of an LED.

3. The LED drive circuit of the present invention provides overcurrent and overvoltage protection for electric components.

### BRIEF DESCRIPTION OF THE DRAWINGS

FIG. 1 illustrates a circuit diagram of a traditional LED drive circuit.

FIG. 2 is a block diagram of an LED drive circuit of the present invention, wherein a reference number 21 refers to a pulse frequency modulation (PFM) module, a reference number 22 refers to a buck converter, a reference number 23 refers to a negative feedback unit, a symbol Vin refers to voltage input, and a symbol Vout refers to voltage output.

FIG. 3 illustrates a circuit diagram of the LED drive circuit shown in FIG. 2 in accordance with a first embodiment of the present invention.

FIG. 4 illustrates a circuit diagram of the LED drive circuit shown in FIG. 2 in accordance with a second embodiment of the present invention, wherein a circuit of a negative feedback unit is different between the first embodiment and the second embodiment of the present invention .

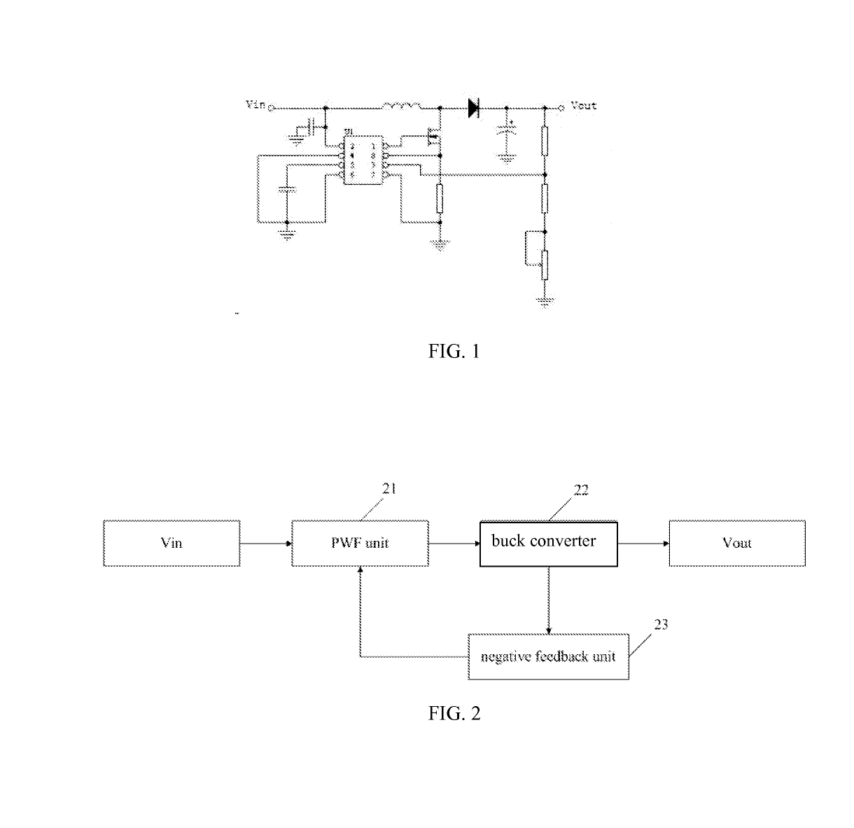

### DETAILED DESCRIPTION OF ILLUSTRATED EMBODIMENTS

Various preferred embodiments will now be described with reference to the figures.

As shown in FIG. 2, a core circuit of the LED drive circuit of the present invention comprises a PFM module 21, a buck converter 22 and a negative feedback unit 23. An LED drive circuit of the present invention comprises but not limits to the following embodiments:

### Embodiment 1

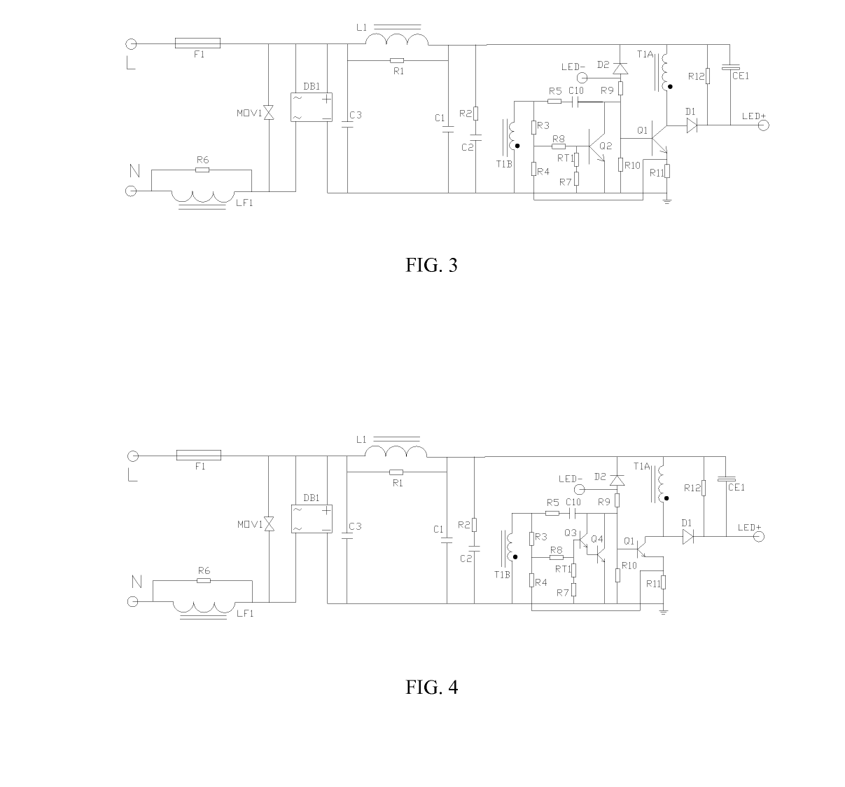

As shown in FIG. 3, an LED drive circuit utilizes a first NPN transistor Q1 and comprises a safety protection portion, an EMI portion and a key functional circuit portion.

Detailed structures of the LED drive circuit are described as follows.

(1) The safety protection portion comprises a protective tube F1, a metal oxide varistor MOV1, and a rectifier bridge BD1.

The protective tube F1 would melt and effectively disconnect the circuit when a short-circuit or over-current condition occurs.

The metal oxide varistor MOV1 is used for the protection of electrical components from excess voltage when an alternating current (AC) voltage exceeds a maximum operating voltage of the metal oxide varistor MOV1.

The rectifier bridge BD1 is used for converting alternating current (AC) to pulsating direct current.

(2) The EMI portion comprises a third capacitor C3, a first inductor L1, a first resistor R1, a first capacitor C1, an arc suppression coil LF1 and a sixth resistor R6.

The third capacitor C3, the first inductor L1, the first resistor R1 and the first capacitor C1 constitute a H-shaped filter. The H-shaped filter, the arc suppression coil LF1 and the sixth resistor R6 are used for preventing electromagnetic interference (EMI).

(3) The key functional circuit portion comprises a second resistor R2, a second capacitor C2, a second backward diode D2, a ninth resistor R9, a fifth resistor R5, a tenth capacitor C10, a first NPN transistor Q1, a transformer T1 consisting of a primary winding T1A and a secondary winding T1B, a first forward diode D1, a filter capacitor CE1, a twelfth resistor R12, a tenth resistor R10, and a negative feedback consisting of a third resistor R3, a forth resistor R4, an eighth resistor R8, a thermistor RT1, a seventh resistor R7, a second NPN transistor Q2 and a eleventh resistor R11.

The second resistor R2 and the second capacitor C2 constitute a R-C snubber circuit. When an external AC supply is connected in series to a leading edge dimmer or a trailing edge dimmer for dimming an LED, a damping circuit in the leading edge dimmer or in the trailing edge dimmer and the external AC supply may resonate at a certain frequency. Therefore, it is necessary to utilize the R-C snubber circuit to avoid such resonance.

The second backward diode D2 is an isolating diode.

The ninth resistor R9 is a starting resistor of the first NPN transistor Q1.

The fifth resistor R5 and the tenth capacitor C10 constitute a time constant. When the resistance of R5 is constant, the capacity of C10 decides the charge storing time and charge dissipating time of C10 and decides the conducting time of the first NPN transistor Q1.

The first NPN transistor Q1 is a switching transistor for switching on/off the LED drive circuit.

The transformer T1 consisting of the primary winding T1A and the secondary winding T1B is a transformer for storing magnetic energy. The transformer T1, together with the first NPN transistor Q1, can convert electric energy to magnetic energy.

The first forward diode D1 is a free-wheeling diode.

The filter capacitor CE1 is used for filtering of undesirable frequencies of the output voltage of the first forward diode D1 and thus makes the DC voltage stable.

The twelfth resistor R12 is a discharge resistor for dissipating weak current when a leading edge dimmer or a trailing edge dimmer is used for dimming an LED.

The tenth resistor R10 is a bias resistor, the tenth resistor R10 functions as a pull-down resistor of the first NPN transistor Q1.

The eleventh resistor R11 is a current limiting resistor with two functions. Firstly the eleventh resistor R11 limits the current flowing through the first NPN transistor Q1 when the first NPN transistor conducts; secondly the eleventh resistor R11 limits the output current of the first NPN transistor Q1. After the voltage over the eleventh resistor R11 and the current going through have been measured, the second NPN transistor Q2 will control the current going through the first NPN transistor Q1 so as to keep the output current of the first NPN transistor Q1 constant.

The third resistor R3, the forth resistor R4, the eighth resistor R8, the thermistor RT1, the seventh resistor R7, the second NPN transistor Q2 and the eleventh resistor R11 constitute a negative feedback unit for preventing output power of the LED drive circuit from being changed, wherein the change of the output power of the LED drive circuit may be caused by the rise of power of the external AC supply or caused by the rise of temperature.

The working principle of the LED drive circuit is as follows. The AC voltage is rectified and converted to pulsating DC voltage by the rectifier bridge BD1. When the first NPN transistor Q1 conducts due to a weak voltage applied to the starting resistor R9, the current flowing through the primary winding T1A increases after the pulsating DC voltage is applied to the primary winding T1A. Based on the principle of electromagnetic induction, an induced voltage is then produced in the primary winding T1A to prevent the current from increasing and accordingly an induced voltage is produced in the secondary winding T1B to charge the tenth capacitor C10 through the fifth resistor R5. When a positive voltage is applied to the base of the first NPN transistor Q1, the first NPN transistor Q1 quickly saturates during the charge storing time of the tenth capacitor C10. When the charges are stably stored in the tenth capacitor C10, a negative voltage is applied to the base of the first NPN transistor Q1 to make the first NPN transistor Q1 unsaturated. As a result, the current flowing through the primary winding T1A decreases, which leads to an induced voltage in the primary winding T1A to prevent the current from decreasing, accordingly an induced voltage is produced in the secondary winding T1B to charge the tenth capacitor C10. When the induced voltage is added to the base of the first NPN transistor Q1, the first NPN transistor Q1 cuts off during the charge storing time of the tenth capacitor C10. This cycle repeats. The working principle of the negative feedback unit is as follows. The third resistor R3, the fourth resistor R4 and the eleventh resistor R11 constitute a biasing circuit for stabilizing the voltage of the base of the second NPN transistor Q2; the eighth resistor R8 is a bias resistor for isolating; the thermistor RT1 and the seventh resistor R7 constitute a pull-down resistor for the second NPN transistor Q2; when temperature of the thermistor RT1 rises, the resistance of the thermistor RT1 increases, thereby the breakover current of the second NPN transistor Q2 increases, namely the voltage of the negative feedback unit increases, which prevents the output power of the LED drive circuit from increasing; in addition, the voltage of the eleventh resistor R11 is applied to the base of the second NPN transistor Q2 to prevent the output power of the LED drive circuit from increasing.

### Embodiment 2

The negative feedback unit in the embodiment 1 can be replaced with other circuits, for example, a combination of two BM, a third NPN transistor Q3 and a forth NPN transistor Q4 shown in FIG. 4 is used to replace the second NPN transistor Q2 shown in FIG. 3.

The safety protection portion and the EMI portion of the LED drive circuit of the present invention may be replaced by other equivalent circuits. All the above are the preferred embodiments of the present invention. It should be noted that any variation or replacement readily figured out by persons skilled in the art within the technical scope of the present invention shall fall within the protection scope of the present invention.

The LED drive circuit of the present invention has low manufacturing cost and high efficiency. The LED drive circuit of the present invention will be widely used in LED lighting applications when connected to a leading edge dimmer or a trailing edge dimmer.

What is claimed is:

1. An LED drive circuit comprising an AC-DC conversion unit at input terminals of the LED drive circuit, characterized in that the LED drive circuit further comprises a transformer, a first NPN transistor (Q1) and a negative feedback unit connected between an emitter and a collector of the first NPN transistor (Q1),
the base of the first NPN transistor (Q1), a tenth resistor (R10) and a negative output terminal of the AC-DC conversion unit are electrically connected in series, a tenth capacitor (C10), a fifth resistor (R5) and a secondary winding (T1B) of the transformer are connected in series between the base of the first NPN transistor (Q1) and the negative output terminal of the AC-DC conversion unit, a primary winding (T1A) of the transformer is electrically connected between the collector of the first NPN transistor (Q1) and a positive output terminal of the AC-DC conversion unit;
the base of the first NPN transistor (Q1), a ninth resistor (R9), a second backward diode (D2) and the positive output terminal of the AC-DC conversion unit are electrically connected in series, a negative output terminal of the LED drive circuit is connected between the ninth resistor (R9) and the second backward diode (D2);
the emitter of the first NPN transistor (Q1), an eleventh resistor (R11) and the negative output terminal of the AC-DC conversion unit are electrically connected in series;
the collector of the first NPN transistor (Q1), a first forward diode (D1) and a positive output terminal of the LED drive circuit are electrically connected in series; and
a twelfth resistor (R12) and a filter capacitor (CE1) are connected in parallel between the positive output terminal of the LED drive circuit and the positive output terminal of the AC-DC conversion unit.

2. The LED drive circuit as claimed in claim 1, characterized in that the negative feedback unit comprises a second NPN transistor (Q2);
a base of the second NPN transistor (Q2), a eighth resistor (R8), a forth resistor (R4) and the emitter of the NPN transistor (Q1) are electrically connected in series, combined bias resistors comprising a seventh resistor (R7) and a thermistor (RT1) are electrically connected between the base of the second NPN transistor (Q2) and the negative output terminal of the AC-DC conversion unit;
a collector of the second NPN transistor (Q2) is electrically connected to the base of the NPN transistor (Q1), the collector of the second NPN transistor (Q2) is also electrically connected in series to the tenth capacitor (C10), the fifth resistor (R5) and one terminal of a third resistor (R3), the other terminal of the third resistor (R3) is electrically connected between the eighth resistor (R8) and the forth resistor (R4); and
an emitter of the second NPN transistor (Q2) is electrically connected to the negative output terminal of the AC-DC conversion unit.

3. The LED drive circuit as claimed in claim 1, characterized in that the negative feedback unit comprises a third NPN transistor (Q3) and a forth NPN transistor (Q4);
a base of the third NPN transistor (Q3) is electrically connected in series to a eighth resistor (R8), a forth resistor (R4) and the emitter of the first NPN transistor (Q1), combined bias resistors comprising a seventh resistor (R7) and a thermistor (RT1) are electrically connected between the base of the third NPN transistor (Q3) and the negative output terminal of the AC-DC conversion unit;
a collector of the third NPN transistor (Q3) and a collector of the forth NPN transistor (Q4) both are connected to the base of the NPN transistor (Q1), the collector of the third NPN transistor (Q3) and the collector of the forth NPN transistor (Q4) are also connected in series to the tenth capacitor (C10), the fifth resistor (R5) and one terminal of a third resistor (R3), the other terminal of the third resistor (R3) is electrically connected to a mid-node of the eighth resistor (R8) and the forth resistor (R4); and
an emitter of the third NPN transistor (Q3) is electrically connected to a base of the forth NPN transistor (Q4), and an emitter of the forth NPN transistor (Q4) is electrically connected to the negative output terminal of the AC-DC conversion unit.

4. The LED drive circuit as claimed in claim 2, characterized in that the LED drive circuit further comprises a second resistor (R2) and a second capacitor (C2) connected in series between the positive output terminal and the negative output terminal of the AC-DC conversion unit.

5. The LED drive circuit as claimed in claim 4, characterized in that a leading edge dimmer or a trailing edge dimmer is connected between the LED drive circuit and an external AC supply.

6. The LED drive circuit as claimed in claim 5, characterized in that the LED drive circuit further comprises an electromagnetic interference prevention unit connected between the positive output terminal and the negative output terminal of the AC-DC conversion unit.

7. The LED drive circuit as claimed in claim 6, characterized in that a part of the electromagnetic interference prevention unit connected to an input terminal of the AC-DC conversion unit comprises a sixth resistor (R6) and an arc suppression coil (LF1) that are connected in parallel between a first input terminal (N) of the LED drive circuit and the AC-DC conversion unit.

8. The LED drive circuit as claimed in claim 6, characterized in that, a part of the electromagnetic interference prevention unit connected to output terminals of the AC-DC conversion unit comprises a first inductor (L1), a first resistor (R1), a first capacitor (C1) and a third capacitor (C3); the first inductor (L1) and the first resistor (R1) that are connected in parallel are connected in series to one terminal of the first capacitor (C1) to form a branch, the branch and the third capacitor (C3) are connected in parallel between the positive output terminal of the AC-DC conversion unit and the negative output terminal of the AC-DC conversion unit; the other terminal of the first capacitor (C1) is an input terminal of a next stage circuit.

9. The LED drive circuit as claimed in claim 6, characterized in that the LED drive circuit further comprises a metal-oxide varistor (MOV1) connected between a first input terminal (N) and a second input terminal (L) of the LED drive circuit.

10. The LED drive circuit as claimed in claim 3, characterized in that the LED drive circuit further comprises a second resistor (R2) and a second capacitor (C2) connected in series between the positive output terminal and the negative output terminal of the AC-DC conversion unit.

11. The LED drive circuit as claimed in claim 10, characterized in that a leading edge dimmer or a trailing edge dimmer is connected between the LED drive circuit and an external AC supply.

12. The LED drive circuit as claimed in claim 11, characterized in that the LED drive circuit further comprises an electromagnetic interference prevention unit connected between the positive output terminal and the negative output terminal of the AC-DC conversion unit.

13. The LED drive circuit as claimed in claim 12, characterized in that a part of the electromagnetic interference prevention unit connected to an input terminal of the AC-DC conversion unit comprises a sixth resistor (R6) and an arc suppression coil (LF1) that are connected in parallel between a first input terminal (N) of the LED drive circuit and the AC-DC conversion unit.

14. The LED drive circuit as claimed in claim 12, characterized in that, a part of the electromagnetic interference prevention unit connected to output terminals of the AC-DC conversion unit comprises a first inductor (L1), a first resistor (R1), a first capacitor (C1) and a third capacitor (C3); the first inductor (L1) and the first resistor (R1) that are connected in parallel are connected in series to one terminal of the first capacitor (C1) to form a branch, the branch and the third capacitor (C3) are connected in parallel between the positive output terminal of the AC-DC conversion unit and the negative output terminal of the AC-DC conversion unit; the other terminal of the first capacitor (C1) is an input terminal of a next stage circuit.

15. The LED drive circuit as claimed in claim 12, characterized in that the LED drive circuit further comprises a metal-oxide varistor (MOV1) connected between a first input terminal (N) and a second input terminal (L) of the LED drive circuit.
